(19) United States
(12) Patent Application Publication
(10) Pub. No.: US 2004/0017394 A1
(43) Pub. Date: Jan. 29, 2004

(54) Image processing apparatus and method, and program for implementing the method

(76) Inventor: Keiji Adachi, Kanagawa (JP)

Correspondence Address: ROSSI & ASSOCIATES, P.O. Box 826, Ashburn, VA, 20146-0826, US

(21) Appl. No.: 10/406,795

(22) Filed: Apr. 3, 2003

(30) Foreign Application Priority Data
Apr. 4, 2002 (JP) 2002-102518 (PAT.
Feb. 19, 2003 (JP) 2003-041218 (PAT.

(51) Int. Cl. G09G 5/00

(52) U.S. Cl. 345/744

(57) ABSTRACT

There is provided an image processing apparatus which enables an image displayed on a display device to be optimally formed according to display capabilities of an information terminal, for display on the information terminal. Window information indicative of the size of a window in an image displayed on the display device is obtained form the display device. Display device information indicative of display capabilities of the information terminal is obtained from the information terminal. The image that is displayed on the display device is changed based on the window information and the display device information, and the changed image is displayed on the information terminal.

### BACKGROUND OF THE INVENTION

1. Field of the Invention

The present invention relates to an image processing apparatus and method, and a program for implementing the method, and more particularly, to an image processing apparatus and method for displaying an image shown on a shared display used in a conference system, on a plurality of portable information terminals used in the same, and a program for implementing the method.

2. Description of the Related Art

In a conventional conference system, an image is displayed on a relatively large shared display so as to be viewed by all attendees. To display this image on a plurality of portable information terminals or the like each equipped with a display having a screen size different from that of the shared display, the image is enlarged or reduced in size according to the screen size of the display, or the resolution of the image is changed.

Many of the portable information terminals, notably PDAs (Personal Digital Assistants), are larger in their height (vertical dimension) than in their width (horizontal dimension) and thus have an aspect ratio different from that of the shared display. Accordingly, when an image shown on the shared display is displayed on the portable information terminals, if the image is reduced in size according to a shorter side of the display of the portable information terminals, a wide area containing no image may be produced on the display screen. On the other hand, when the image is reduced in size according to a longer side of the display of the portable information terminals, a certain area of the image cannot be displayed within the display screen thereof.

To solve this problem, for example, an image processing apparatus has been proposed which converts character information in a document into an optimum size when image data of the document is outputted for display on a display and output medium having a display and output size different from that of a shared display, thereby enabling the effective use of the display and output medium (e.g. Japanese Patent Laid-Open Patent Publication (Kokai) No. 08-152871).

However, with the above described conventional image processing apparatus, when an image shown on the shared display is displayed on the portable information terminals, the image is only uniformly enlarged or reduced in size according to the screen size of the display of the portable information terminals, but the layout of the image remains unchanged. Therefore, if the size of the image is uniformly reduced, character image or the like becomes difficult to read. If the image is displayed on a portable information terminal having an aspect ratio different from that of the shared display, the size of the image may be reduced more than necessary or part of the image may be lost. It is thus difficult to display an image properly reduced and laid out on the portable information terminal.

Further, the above described conventional image processing apparatus only changes a character font but fails to prevent a window from becoming partially indisplayable. Therefore, it is still a problem to be solved that the image displayed on the screen of the portable information terminals can be difficult to view or make out.

### SUMMARY OF THE INVENTION

It is an object of the present invention to provide an image processing apparatus and method which enable an image displayed on a display device to be optimally formed according to display capabilities of an information terminal, for display on the information terminal, and a program for implementing the method.

To attain the above object, in a first aspect of the invention, there is provided an image processing apparatus that is connected to a display device and an at least one information terminal, comprising a first information-obtaining device that obtains window information from the display device, the window information being indicative of a size of a window in displayed on the display device, a second information-obtaining device that obtains display device information from the information terminal, the display device information being indicative of display capabilities of the information terminal, changing device that changes size of the window displayed on the display device based on the window information and the display device information, and a display device that causes the changed window to be displayed on the information terminal.

With the image processing apparatus according to the first aspect of the present invention, the window information indicative of the size and position of the window in the image displayed on the display device is obtained from the display device. Further, the display device information indicative of the display capabilities of the information terminal is obtained from the information terminal. Then, the size of the window displayed on the display device is changed based on the window information and the display device information, for display on the information terminal. As a result, the window displayed on the display device can be optimally formed according to display capabilities of the information terminal, for display on the information terminal.

Preferably, the changing device changes the size and position of the window displayed on the display device based on the height, width, and resolution of the window. As a result, the window displayed on the display device can be optimally formed according to the display capabilities of the information terminal.

Preferably, the display device information comprises a resolution of the information terminal with which the image can be displayed.

Preferably, the changing device changes the size and a position of the window displayed on the display device based on a height and a width of the window and a resolution of the information terminal with which the image can be displayed.

Preferably, the changing device comprises a size reduction ratio-determining device that determines a size reduction ratio by which the window displayed on the display device is reduced, based on a height and a width of the window and a resolution of the information terminal with which the image can be displayed.

More preferably, the display device comprises a scroll device that scrolls a screen of the window, and wherein an amount of scroll movement of the screen carried out by the scroll device is reduced according to the size reduction ratio determined by the size reduction ratio-determining device.

Also preferably, when the window is reduced in size by the size reduction ratio, if a size of characters contained in the window becomes smaller than a predetermined size, the changing device changes the characters by a size reduction ratio that causes the size of the characters to be changed to the predetermined size.

Preferably, the display device displays the changed window at a predetermined position in a screen displayed by the information terminal.

Preferably, the changing device has a format in which a display position of the window is preset according to the display capabilities of the information terminal, and changes a layout of the window displayed on the display device based on the format.

Preferably, the window comprises a plurality of windows, and the changing device changes the window such that the plurality of windows do not overlap when the plurality of windows are displayed on the information terminal.

To attain the above object, in a second aspect of the invention, there is provided an image processing method for an image processing apparatus that is connected to a display device and an at least one information terminal, comprising a first information-obtaining step of obtaining window information from the display device, the window information being indicative of a size and a position of a window displayed on the display device, a second information-obtaining step of obtaining display device information from the information terminal, the display device information being indicative of display capabilities of the information terminal, and an changing step of changing size of the window displayed on the display device based on the window information and the display device information, and a display step of causing the changed window to be displayed on the information terminal.

With the image processing method according to the second aspect of the invention, the same advantageous effects as provided by the first aspect of the invention can be obtained.

To attain the above object, in a third aspect of the invention, there is provided a program for causing a computer to execute an image processing method for an image processing apparatus connected to a display device and an at least one information terminal, the program comprising, a first information-obtaining module for obtaining window information from the display device, the window information being indicative of a size and a position of a window displayed on the display device, a second information-obtaining module for obtaining display device information from the information terminal, the display device information being indicative of display capabilities of the information terminal, and an changing module for changing size of the window displayed on the display device based on the window information and the display device information, and a display module for causing the changed image to be displayed on the information terminal.

With the program according to the third aspect of the invention, the same advantageous effects as provided by the first aspect of the invention can be obtained.

The above and other objects, features, and advantages of the invention will become more apparent from the following detailed description taken in conjunction with the accompanying drawings.

### BRIEF DESCRIPTION OF THE DRAWINGS

FIG. 1 is a block diagram showing the arrangement of a conference system incorporating an image processing apparatus according to an embodiment of the present invention;

FIGS. 2A and 2B are schematic diagrams showing an example of screens displayed on a display device and an information terminal in FIG. 1, wherein FIG. 2A shows a display screen on the display device, and FIG. 2B shows a display screen on the information terminal;

FIG. 3 is a flowchart showing an image processing process executed by a control section in FIG. 1;

FIG. 4 is a flowchart showing a window layout-changing process in a step S3 in FIG. 3; and

FIG. 5 is a view showing an example of window parameters stored in a window information storage section 4 in FIG. 1.

### DETAILED DESCRIPTION OF THE PREFERRED EMBODIMENTS

The present invention will now be described below with reference to the drawings showing an embodiment of the present invention.

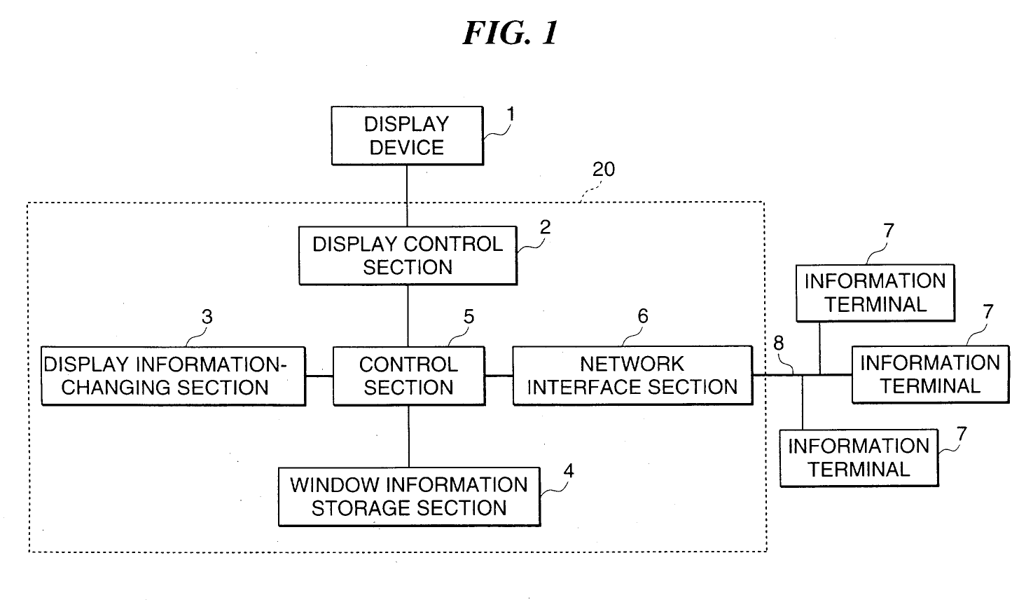

FIG. 1 is a block diagram showing the arrangement of a conference system incorporating an image processing apparatus according to an embodiment of the present invention.

As shown in FIG. 1, the present conference system is comprised of a display device (shared display) 1 implemented by a relatively large display that can be viewed by all attendees at a conference, an image processing apparatus 20 connected to the display device 1 and implemented by a computer or the like, and a plurality of portable information terminals (hereinafter simply referred to as the “information terminals”) 7 connected to the image processing apparatus 20 via a network 8, such as a LAN, and each implemented by a PDA (Personal Digital Assistant) or the like. Each information terminals 7 is equipped with a display device (terminal display) having a screen size and display capabilities including a displayable resolution, which are different from those of the display device 1.

The image processing apparatus 20 is comprised of a display control section 2 that controls an image displayed on the display device 1, a display information-changing section 3 that changes the image displayed on the display device 1 based on the display capabilities of the terminal display to cause the information terminal 7 to display an image equivalent to the image displayed on the display device 1, a window information storage section 4 implemented by a ROM (Read Only Memory), a RAM (Random Access Memory), or the like, a control section 5 implemented by a CPU, MPU, or the like, for control of each section of the apparatus 20, and a network interface section 6 that controls communications between the image processing apparatus 20 and the plurality of information terminals 7.

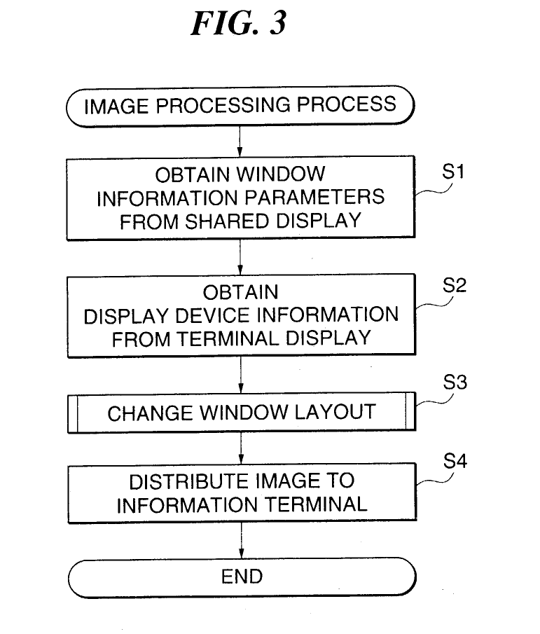

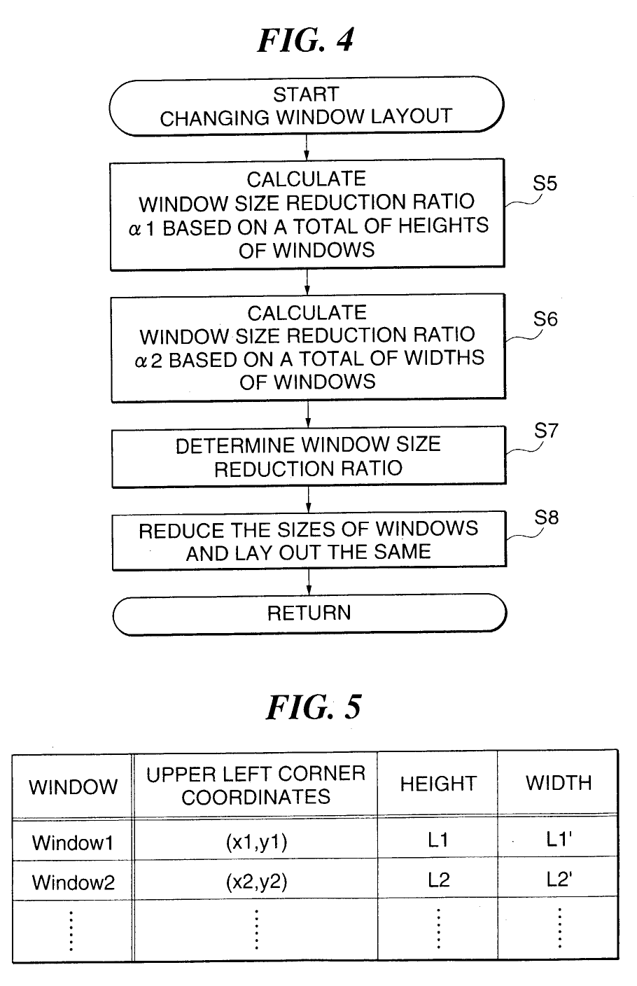

Further, the image processing apparatus 20 has a predetermined program stored in the ROM functioning as the window information storage section 4, and the control section 5 reads out this program to execute processes in FIGS. 3 and 4, described hereinafter.

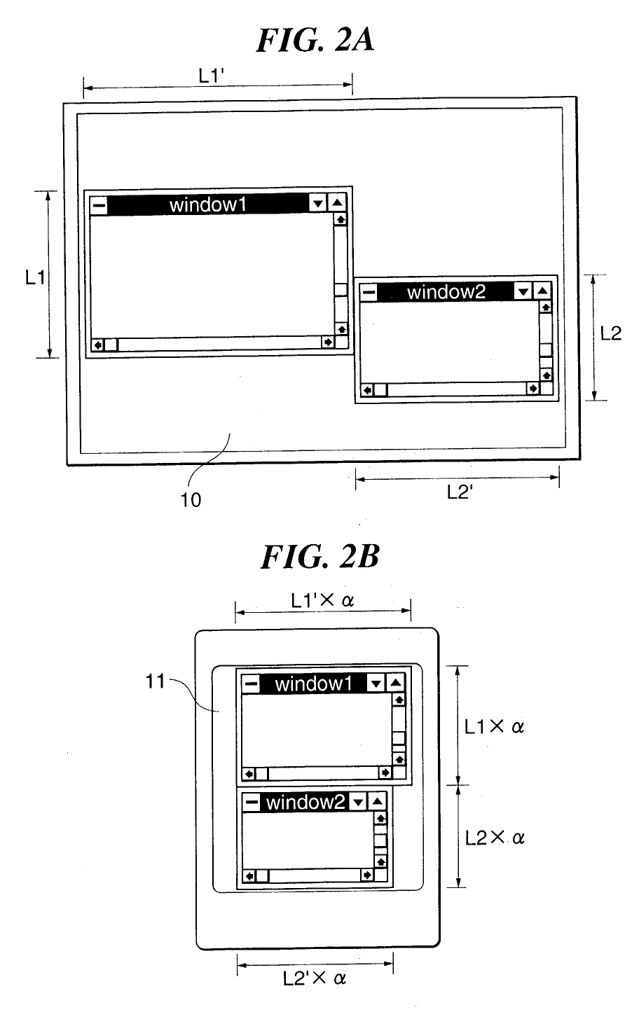

FIGS. 2A and 2B are schematic diagrams showing an example of screens displayed on the display device 1 and each information terminal 7 in FIG. 1, wherein FIG. 2A shows a display screen on the display device 1 and FIG. 2B shows a display screen on the information terminal 7.

As shown in FIG. 2A, a screen 10 is an example of an image displayed on the display device 1. Displayed on the screen 10 are the two windows of a window 1 and a window 2, which have predetermined sizes and are disposed at predetermined positions, respectively. In FIG. 2B, a screen 11 is an example of an image displayed on the information terminal 7. The windows 1 and 2, displayed on the screen 10 of the display device 1, are displayed on the screen 11 after reducing their sizes (their heights and widths) to respective sizes multiplied by a factor of a and changing the layout of the windows 1 and 2.

Assuming that the height of the window 1 in the screen 10 is represented by L1, and the height of the window 2 by L2, the height of the window 1 in the screen 11 is α times the height L1 (L1×α), and the height of the window 2 in the screen 11 is α times the height L2 (L2×α).

FIG. 3 is a flowchart showing an image processing process executed by the control section 5 in FIG. 1.

In FIG. 3, first, the control section 5 obtains window information parameters indicative of the sizes (dimensions) and positions of the windows in the image displayed on the display device 1 which is the shared display, by the display control section 2, and stores these window information parameters in the window information storage section 4 (step S1). FIG. 5 shows an example of window parameters stored in the window information storage section 4. The window information parameters are composed of the upper left corner coordinates (x1, y1), height L1, and width L1′ of a window in the image displayed on the display device 1. If a plurality of windows are displayed on the display device 1 as shown in FIG. 2A, the upper left corner coordinates (x1, y1), (x2, y2), . . . , heights L1, L2, . . . , and widths L1′, L2′, . . . of these windows are stored in the window information storage section 4 as window information parameters.

Then, display device information is obtained from the plurality of information terminals 7 connected to the image processing apparatus 20 via the network 8, the display device information being indicative of the display capabilities of the terminal displays of the information terminals 7, i.e. the resolution of the terminal displays with which the image can be displayed (step S2). The display information-changing section 3 changes the layout of the windows in the displayed image, based on the window information parameters and the display device information (step S3). Subsequently, the changed image is distributed (transmitted) to the information terminals 7 (step S4) for display thereon, followed by terminating the present process.

With the present process, when an image displayed on the display device 1 is displayed on the information terminals 7 equipped with the terminal displays having display capabilities different from those of the display device 1, the image can be enlarged or reduced in size and laid out so as to be optimally formed based on the display capabilities of the terminal displays, thereby preventing character images or the like from becoming difficult to view or make out.

FIG. 4 is a flowchart showing the window layout-changing process in the step S3 in FIG. 3.

As shown in FIG. 4, first, the heights L1, L2, . . . of all windows are read out from the window information parameters stored in the window information storage section 4. The heights L1, L2, . . . are then added together to obtain a total height TL. Assuming that the resolution of the terminal display of each information terminal 7 is represented by (HX, HY) a window size reduction ratio α1 is determined by calculating TL/HX (step S5).

Then, the widths L1′, L2′, . . . of all the windows are read out from the window information parameters stored in the window information storage section 4. Assuming that the largest of these widths is represented by MaxL′, a window size reduction ratio α2 is determined by calculating MaxL′/HY (step S6). Subsequently, the smaller of the window size reduction ratios α1 and α2 is determined to be a window size reduction ratio α (step S7). Then, the heights L1, L2, . . . and widhts L1′, L2′, . . . of all the windows in the image displayed on the display device 1 are reduced by the window size reduction ratio α, and the windows are arranged such that they do not overlap each other. In this state, the coordinates of a display position of each window (the coordinates of the upper left corner of the window) are determined (step S8). Then, the changed image is transmitted to the information terminals 7 via the network interface section 6 and displayed on them as shown in the screen 11. The process then returns.

Here, a description will be given of the images displayed in the screens 10 and 11. Assuming that the image displayed on the screen 10 of the display device 1 is reduced in size by the size reduction ratio α, it may be displayed in the screen 11 as such a small image that the viewer cannot make out what it is. To eliminate this inconvenience, the minimum size of characters may be preset so that if the size of characters resulting from the size reduction by the size reduction ratio α is smaller than the minimum size, the size of the window is reduced by the size reduction ratio α and the size of the contents or character images displayed in the window is set to the miminum size. In this case, the respective ratios of total lengths of scroll bars to be displayed by scroll in the screens 10 and 11 to corresponding dimensions (height S and width S) of the screens 10 and 11 are different from each other.

According to the above described embodiment, the window information parameters are obtained which are indicative of the heights, widths, and the like of windows in a image displayed on the display device 1 and the display device information is obtained from the information terminals 7 connected to the image processing apparatus via the network 8, the display device information being indicative of the resolution of the terminal displays of the information terminals 7. Then, the window size reduction ratio α is determined based on the window information parameters and the display device information. The image displayed on the display device 10 is changed such that all the windows in the image are reduced in size by the window size reduction ratio α, and at the same time the windows do not overlap each other. This makes it possible to optimally form the image shown on the display device 1 based on the display capabilities of the information terminals 7 and display the same on the information terminals 7.

Although in the above described embodiment, a plurality of windows whose sizes are reduced by the window size reduction ratio α are arranged such that they do not overlap each other, this is not limitative but the plurality of windows may be arranged at predetermined positions in the screen displayed on the terminal displays of the information terminals 7. Alternatively, a format may be provided in which the display positions of the windows are set based on the display capabilities of the terminal displays of the information terminals 7, whereby the layout of the windows displayed on the display device 1 may be changed based on this format.

Further, in the above described embodiment, as shown in FIG. 2, all windows may be provided with a horizontal scroll bar (or a scroll key) that scrolls the screen in a lateral direction and a vertical scroll bar (or a scroll key) that scrolls the screen in a vertical direction. In this case, when the window is reduced in size by the size reduction ratio α, the amount of scroll movement of the screen carried out by the scroll bar may be decreased according to the size reduction ratio α.

Furthermore, although in the above described embodiment, the size of the image (the amount of and scroll movement) is reduced, this is not limitative, but of course, similar effects are produced when the image is changed such that it is enlarged in size.

The above described display device 1 may be a liquid crystal projector or a liquid crystal panel or PDP (plasma display panel) with a large-sized screen. Moreover, although in the above described embodiment, the display device 1 is arranged separate from the image processing apparatus 20, this is not limitative, but the display device 1 may be integrated into the image processing apparatus 20. The information terminal 7 is implemented by a PDA equipped with a relatively small terminal display formed by a liquid crystal panel or the like. However, the information terminal 7 may be a notebook personal computer or a desk top personal computer. Further, although in the above embodiment, the information terminals 7 are connected to the image processing apparatus 20 via the network 8 using wired communication, this is not limitative but they may be connected to the image processing apparatus 20 using wireless communication. It is needless to say that this wireless communication includes various methods such as infrared communication and Bluetooth.

The above described window information storage section 4 may be a storage device such as a hard disk. Although in the above described embodiment, the display information-changing section 3 is implemented by peripheral equipment, an expansion card, or the like, this is not limitative but it may be implemented by software such as a device driver.

It is to be understood that the object of the present invention may be accomplished by supplying a computer or a CPU with a program (corresponding to the processes described hereinabove with reference to the flowcharts of FIGS. 3 and 4) of software that realizes the functions of the above described embodiment, and causing the computer or CPU to read out and execute the supplied program from a storage medium storing the same.

In this case, the program is supplied directly by the storage medium in which it is recorded or by downloading it from another computer, database, or the like all of which are not shown connected to the Internet, a commercial network, a local area network, or the like.

Further, the program has only to be able to cause a computer to execute the functions of the above described embodiment. The program may thus be an object code, a program executed by an interpreter, script data supplied to an OS, or the like.

Furthermore, it is to be understood that the object of the present invention may also be accomplished by supplying a system or an apparatus with a storage medium in which a program code of software which is encoded and realizes the functions of any of the above described embodiment, and causing the computer (CPU or MPU) of the system or apparatus to read out and execute the program code stored in the storage medium.

In the above described embodiment, the program is stored in the ROM. However, the present invention is not limited to this. Examples of the storage medium for supplying the program include a floppy (registered trade mark) disk, a hard disk, an optical disk, a magneto-optical disk, a CD-ROM, a CD-R, a CD-RW, a DVD-ROM, a DVD-R, a DVD-RAM, a DVD+RW, a DVD-W, a magnetic tape, a non-volatile memory card, a RAM, NV-RAM and other ROMs in which the program can be stored.

What is claimed is:

1. An image processing apparatus that is connected to a display device and an at least one information terminal, comprising:
a first information-obtaining device that obtains window information from the display device, the window information being indicative of a size of a window displayed on the display device;
a second information-obtaining device that obtains display device information from the information terminal, the display device information being indicative of display capabilities of the information terminal;
a changing device that changes size of the window displayed on the display device based on the window information and the display device information; and
a display device that causes the changed window to be displayed on the information terminal.

2. An image processing apparatus according to claim 1, wherein the window information comprises a height, a width, and coordinates of the window.

3. An image processing apparatus according to claim 1, wherein the display device information comprises a resolution of the information terminal with which the image can be displayed.

4. An image processing apparatus according to claim 1, wherein said changing device changes the size and a position of the window displayed on the display device based on a height and a width of the window and a resolution of the information terminal with which the image can be displayed.

5. An image processing apparatus according to claim 1, wherein said changing device comprises a size reduction ratio-determining device that determines a size reduction ratio by which the window displayed on the display device is reduced, based on a height and a width of the window and a resolution of the information terminal with which the image can be displayed.

6. An image processing apparatus according to claim 5, wherein said display device comprises a scroll device that scrolls a screen of the window, and wherein an amount of scroll movement of the screen carried out by said scroll device is reduced according to the size reduction ratio determined by said size reduction ratio-determining device.

7. An image processing apparatus according to claim 5, wherein when the window is reduced in size by the size reduction ratio, if a size of characters contained in the window becomes smaller than a predetermined size, said changing device changes the characters by a size reduction ratio that causes the size of the characters to be changed to the predetermined size.

8. An image processing apparatus according to claim 1, wherein said display device displays the changed window at a predetermined position in a screen displayed by the information terminal.

9. An image processing apparatus according to claim 1, wherein said changing device has a format in which a display position of the window is preset according to the display capabilities of the information terminal, and changes a layout of the window displayed on the display device based on the format.

10. An image processing apparatus according to claim 1, wherein the window comprises a plurality of windows, and said changing device changes the window such that the plurality of windows do not overlap when the plurality of windows are displayed on the information terminal.

11. An image processing method for an image processing apparatus that is connected to a display device and an at least one information terminal, comprising:
a first information-obtaining step of obtaining window information from the display device, the window information being indicative of a size and a position of a window displayed on the display device;
a second information-obtaining step of obtaining display device information from the information terminal, the display device information being indicative of display capabilities of the information terminal lay; and
a changing step of changing size of the window displayed on the display device based on the window information and the display device information; and
a display step of causing the changed window to be displayed on the information terminal.

12. An image processing method according to claim 11, wherein the window information comprises a height, a width, and coordinates of the window.

13. An image processing method according to claim 11, wherein the display device information comprises a resolution of the information terminal with which the image can be displayed.

14. An image processing method according to claim 11, wherein said changing step comprises changing the size and the position of the window displayed on the display device based on a height and a width of the window and a resolution of the information terminal with which the image can be displayed.

15. An image processing method according to claim 11, wherein said changing step comprises a size reduction ratio-determining step of determining a size reduction ratio by which the window displayed on the display device is reduced, based on a height and a width of the window and a resolution of the information terminal with which the image can be displayed.

16. An image processing method according to claim 15, wherein said display step comprises a scroll step of scrolling a screen of the window, and wherein an amount of scroll movement of the screen carried out in said scroll step is reduced according to the size reduction ratio determined in said size reduction ratio-determining step.

17. An image processing method according to claim 15, wherein when the window is reduced in size by the size reduction ratio, if a size of characters contained in the window becomes smaller than a predetermined size, said changing step comprises changing the characters by a size reduction ratio that causes the size of the characters to be changed to the predetermined size.

18. An image processing method according to claim 11, wherein said display step comprises displaying the changed window at a predetermined position in a screen displayed by the information terminal.

19. An image processing method according to claim 11, wherein said changing step uses a format in which a display position of the window is preset according to the display capabilities of the information terminal, and comprises changing a layout of the window displayed on the display device based the format.

20. A program for causing a computer to execute an image processing method for an image processing apparatus connected to a display device and an at least one information terminal, the program comprising:
a first information-obtaining module for obtaining window information from the display device, the window information being indicative of a size and a position of a window displayed on the display device;
a second information-obtaining module for obtaining display device information from the information terminal, the display device information being indicative of display capabilities of the information terminal; and
a changing module for changing size of the window displayed on the display device based on the window information and the display device information; and
a display module for causing the changed image to be displayed on the information terminal.
